(19) United States
(12) Patent Application Publication
(10) Pub. No.: US 2025/0054019 A1
(43) Pub. Date: Feb. 13, 2025

(54) VENDOR AGNOSTIC LOYALTY PROGRAM

(71) Applicant: Patron Points, Inc., Woodbury, MN (US)

(72) Inventors: Erik W. Ogren, Stillwater, MN (US); Kyle J. Davis, Watertown, MN (US); Michael G. Liebl, Burnsville, MN (US)

(21) Appl. No.: 18/800,906

(22) Filed: Aug. 12, 2024

Related U.S. Application Data
(60) Provisional application No. 63/532,190, filed on Aug. 11, 2023.

(51) Int. Cl. G06Q 30/0226; G06Q 30/0211

(52) U.S. Cl. CPC G06Q 30/0229; G06Q 30/0211

(57) ABSTRACT

A novel and advantageous vendor agnostic loyalty program. More particularly, a novel and advantageous loyalty program that spans multiple vendors and multiple manufacturers. The loyalty program may be used by a customer at one or a plurality of vendors. The loyalty program tracks what is bought by each customer at what location of what vendor, how many points or rewards are accumulated by each customer at what location of what vendor, and what product incentives for what products from what manufacturer are redeemed at what location of what vendor.

### CROSS-REFERENCE TO RELATED APPLICATIONS

The present disclosure claims priority to Provisional Application No. 63/532,190, entitled Vendor Agnostic Loyalty Program, and filed 11 Aug. 2023, the content of which is hereby incorporated by reference herein in its entirety

### FIELD OF THE INVENTION

The present disclosure relates to a novel and advantageous loyalty program. Particularly, the present disclosure relates to a novel and advantageous vendor agnostic loyalty program. More particularly, the present disclosure relates to a novel and advantageous loyalty program that spans multiple vendors and multiple manufacturers.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A loyalty program is a marketing strategy designed to encourage customers to shop at or use the services of a business associated with the program. A loyalty program generally incentivizes customers to frequent a specific business in a variety of ways. Generating points for specific patronage and providing a reward based on accumulated points, member only discounts, frequent purchase clubs and other rewards such as a coupon for a discount, a free item, etc. are examples.

A loyalty program typically involves the operator of a particular program setting up an account for a customer of a business associated with the program, and issuing a membership number associated with the customer. The membership number may be tied to a loyalty card that identifies the cardholder as a participant in the program. Alternatively, a loyalty app may be used and the membership number tied to the app such that a customer can access the loyalty program without a card being present. Alternatively, a membership number can be tied to a phone number that the customer can enter during check out at the point of sale system.

By presenting the loyalty card, or other identifier, customers receive either a discount on the current purchase, purchase credits like a digital punch on a club punch card, an allotment of points that they can use for future purchases at a specific business, or other rewards the consumer finds valuable.

Loyalty programs cover most types of commerce, each having varying features and rewards schemes, including in banking, entertainment, hospitality, retailing and travel. The market approach has shifted from product-centric to a customer-centric one due to a highly competitive market and a wide array of services offered to customers. Loyalty programs have been described as a form of centralized virtual currency, one with unidirectional cash flow, since reward points can be exchanged into a good or service but not into cash.

Loyalty programs are typically specific to a single business, vendor, or retailer). For example, Target™ Stores has its own loyalty program and rewards people for shopping at or making certain purchases at Target. Some programs exist, such as ibotta™, wherein a customer can buy items at a plurality of retailers and thereafter send a picture of the receipt to the loyalty program and receive a gift card for the amount of whatever coupon was being used. This is labor intensive for the customer.

Loyalty programs are commonly tied to a vendor, not a manufacturer. While the loyalty program may give some insight to the vendor regarding sale of products, in many cases, that information is not available to a manufacturer. For example, a manufacturer typically sells products to a distributor and the distributor then sells such products to a retailer. While the manufacturer detail about what is sold to the distributor, the they do not have information about further downstream sales.

There is a need in the art for an easy to use vendor agnostic loyalty program. There is further a need in the art for a loyalty program that gives data analytics to a manufacturer.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

In one embodiment, a loyalty program system comprising a program hub, a mobile app, a vendor interface, and a manufacturer interface is provided. The mobile app is usable by a customer at a plurality of vendors. The program hub tracks executed purchases made by the customer at each of the vendors, and loads program incentives earned by the customer based on the executed purchases for redemption for future purchases at one of the plurality vendors to the mobile app. The mobile app may be customizable for one or more of the plurality of vendors. The vendor interface communicates transaction data and customer purchase data to the program hub. The manufacturer interface communicates one or more program incentives available for the customer to the program hub. The customer provides customer identifying information to one of the plurality of vendors when making a current purchase. The vendor interface communicates the current customer purchase data and the customer identifying information to the program hub. The program hub stores customer information and vendor information. The program hub communicates an available program incentive for the current purchase to the vendor interface and the vendor interface applies the available program inventive to the current purchase. The program incentive may comprise a deal, discount, coupon, or the like.

The transaction data may include scan data and loyalty data. The loyalty data may include what products were purchased by the customer using the loyalty program at what time at which one of the plurality of vendors. The loyalty data may be communicated by the program hub to the manufacturer and or one of the plurality of vendors.

The program hub can track a value for redeemed program incentives at one of the plurality of vendors for the manufacturer and coordinates payment of the value from the manufacturer to the one of the plurality of vendors.

In a further embodiment, a method of administering a vendor agnostic loyalty program. The method comprises registering a plurality of vendors with the loyalty program, providing a mobile app for use by a customer at each of the plurality of vendors, registering a customer with the loyalty program, and registering a manufacturer with the loyalty program. The method further comprises receiving from the manufacturer a program incentive for redemption by the customer at at least one of the plurality of vendors, tracking past purchases made by the customer at each of the vendors, establishing when the customer's purchases have qualified the customer for the program incentive, and communicating the program incentive to one of the plurality of vendors for use on a current purchase by the customer. The program incentive may comprise a deal, discount, coupon, or the like. The method may include applying the program incentive to the current purchase and coordinating payment from the manufacturer to the one of the plurality of vendors for a value of the program incentive applied to the current purchase. The method may include evaluating customer information for compliance with legal requirements for the current purchase.

The method may further comprise receiving data, such as transaction data, from the plurality of vendors. The date may comprise scan data and loyalty data. The loyalty data may include what products were purchased by the customer using the loyalty program at what time at which one of the plurality of vendors. The method include communicating the loyalty data to the manufacturer and/or one of the plurality of vendors.

In yet a further embodiment, a vendor agnostic loyalty program comprising a customer module, a vendor module, a manufacturer module, a program hub, a mobile app, a vendor interface, and a manufacturer interface is provided. A customer can use the loyalty program at each of a plurality of vendors. The customer module may include a customer profile for a customer, the customer profile including customer information relating to the customer including identifying information relating to the customer. The vendor module may include a vendor profile for a plurality of vendors, the vendor profile including vendor information relating to each vendor. The manufacture module may include a manufacturer profile for a plurality of manufacturers, the manufacturer profile including manufacturer information relating to each manufacturer. The program hub stores information from the customer module, vendor module, and the manufacturer module. The mobile app is usable by the customer at the plurality of vendors. The mobile app tracks executed purchases made by the customer at each of the vendors and loads program incentives earned by the customer based on the executed purchases for redemption for future purchases at one of the plurality vendors. The vendor interface communicates transaction data and customer purchase data to the program hub. The manufacturer interface communicates one or more program incentives available for the customer to the program hub.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 illustrates a block view of a loyalty program hub of the loyalty program, in accordance with one embodiment.

FIG. 2 illustrates data used by the loyalty program, in accordance with one embodiment.

FIG. 3 illustrates two customers performing transactions at a respective store using a loyalty program in accordance with one embodiment.

FIG. 4 illustrates data flow between the consumer, retailer, and loyalty hub at the time of a transaction, in accordance with one embodiment.

FIG. 5 illustrates further detail about the information sent by the vendor to the hub and the information sent from the hub to the vendor, in accordance with one embodiment.

FIG. 6 illustrates broad steps performed within the loyalty program.

FIG. 7 illustrates a loyalty program system, in accordance with one embodiment.

FIG. 8 illustrates aspects of a Loyalty Program controller, in accordance with one embodiment.

### DETAILED DESCRIPTION

The present disclosure relates to a novel and advantageous loyalty program. Particularly, the present disclosure relates to a novel and advantageous vendor agnostic loyalty program. More particularly, the present disclosure relates to a novel and advantageous loyalty program that spans multiple vendors and multiple manufacturers. The loyalty program may further be configured to give data analytics to the vendor and to the manufacturer. The data analytics may be used by the vendor and/or the manufacturer to customize offerings, including deals, discounts, and coupons (collectively referred to as “program incentives”), to customers based on purchasing behavior. The loyalty program disclosed herein provides significant advantages to each of customers, retailers, and manufacturers over current loyalty program offerings.

At a customer level, the loyalty program provides a single sign up program that can be used at a plurality of locations. By using the loyalty program, the customer may be provided with program incentives specific to their preferences.

At a vendor level, the loyalty program provides a robust program that can enhance the vendor's relationship with a manufacturer (often largely absent because of the intervening distributor) and strengthen the vendor's relationship with customers by providing customer-targeted program incentives. The loyalty program can be implemented by, and customized to, a vendor of any size without requiring significant development by the vendor.

At a manufacturer level, the loyalty program provides detailed information and specificity about what products are sold in what volume at what location on what dates. In contrast, manufacturers currently typically only know what is sold to a particular distributor, not what volume of what product is sold at a specific location. Using this information, the manufacturer can develop and provide program incentives more likely to be used by a customer or to incentivize purchase of a product by a customer.

As used herein, a customer is an individual or group of individuals who purchase goods or services from a vendor. It is to be appreciated that the terms customer and consumer are used interchangeably herein. A manufacturer refers to an entity that makes or produces (including through a third party) goods for sale. A vendor refers to a retailer, a convenience store owner, or other entity or person that sells a product or provides a service to a customer.

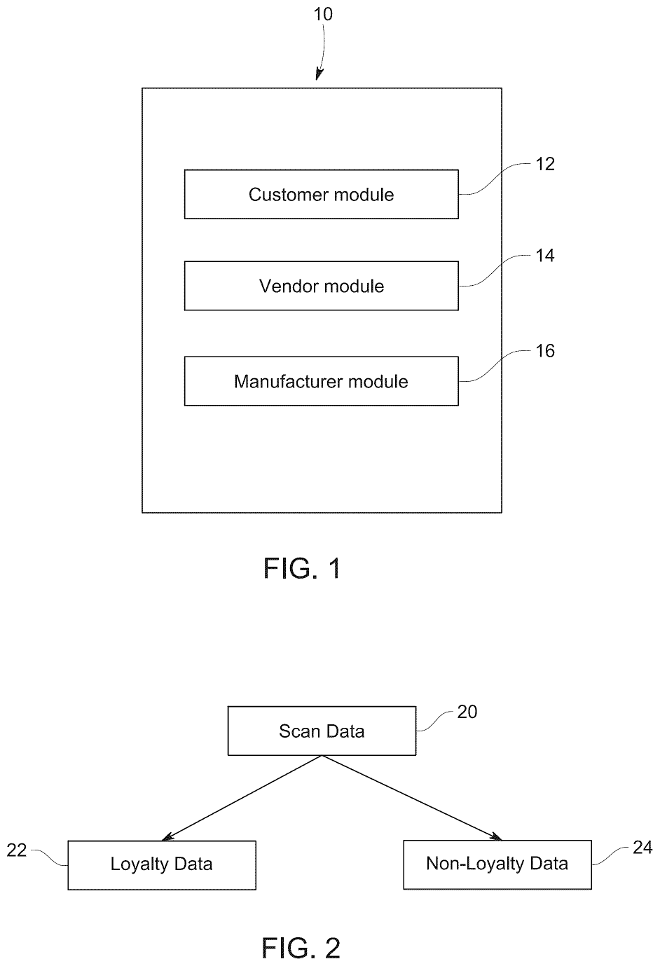

FIG. 1 illustrates a block view of a loyalty program hub 10 of the loyalty program, in accordance with one embodiment. The loyalty program hub includes a customer module 12, a vendor module 14, and a manufacturer module 16. The modules are conceptual modules relating to the functionality and data associated with each of the customer, the vendor, and the manufacturer.

Customer module 12. The customer module includes a customer profile for each loyalty customer. The customer profile may include identifying information relating to the customer such as name, phone number, email address, address, etc. In some embodiments, the customer profile may include date of birth and age. The customer module associates scan data of a loyalty customer. This can be used to build out customer preferences such that program incentives may be customized to the customer. Detail about the history of transactions for a customer may be saved at the loyalty program hub. That information may be accessible to the customer or the manufacturer. The customer may access historical transaction information via a mobile app, the web, or other.

Vendor module 14. The vendor module includes a vendor profile for each registered vendor. The vendor profile may include information including vendor name, vendor locations, products sold at the vendor, etc. It is to be appreciated that the terms vendor, retailer, and merchant are used interchangeably herein.

The loyalty program may be configured as a universal program usable across a plurality of vendors. In one embodiment a standard interface that is universal across all vendors is provided as a universal mobile app with the same offers and perks.

In another embodiment, any given vendor may customizer the user interface of the app for use at their location. The loyalty program may be customizable for a vendor. The vendor can choose visual or other customization. In such an embodiment, the loyalty program may be set up in a proprietary app for the vendor that is customized for their usage. The universal app contents of the loyalty program are loaded into the customized app. The vendor may add additional promotions that are unique to them.

In some embodiments, the vendor can choose what offers are available, how many points are rewarded, and how many points are required to redeem program incentives such as rewards and other perks. These may be chosen based on the vendor's specific needs such that a vendor can design a flexible program that will best fits its unique goals for growth.

Manufacturer module 16. The manufacturer module includes a manufacturer profile for each registered manufacturer. Using the loyalty program, a manufacturer may set up rewards that are applicable to all vendors, all locations of vendors, or some subset of vendors. At the manufacturer module, specific program incentives may be set up. These may use detail from historical transactions. For example, a manufacturer may offer a reward only to customers who have made a purchase of a specific item in a set period of time or customers who have not made a purchase of a specific item in a set period of time. The item triggering the reward may be the item for which the reward is targeted, referred to as a reward item, or may be an item that indicates a possible interest in the item for which the reward item.

In some embodiments, the loyalty program can set specific marketing goals associated with a specific manufacturer that can be applied across all vendors using the loyalty program. In such embodiments, the manufacturer can provide rewards and other perks associated with a certain number of points that can be redeemed and/or items purchased by a customer at any vendor using the loyalty program.

A benefit of the loyalty program is the data analytics provided. The loyalty program gathers data about sale transactions and provides granularity that can be passed to a manufacturer. More specifically, with any transaction associated with a loyalty program user (via input into the POS or other), the loyalty program gathers all line item data, including, for example, what was sold, for what price, at what time, on what day, in what location. The loyalty program may further gather data about sales transactions that are not associated with a loyalty program user such that that information can be used to assess lost opportunities.

FIG. 2 illustrates data used by the loyalty program. That data may include scan data 20, loyalty data 22, non-loyalty data 24, and other data.

A vendor collects “scan data” about all sale transactions. Scan data 20 is a metric that records data whenever customers make a purchase. When a customer makes a purchase at the point of sale (POS), the information is captured and stored for analysis. The data collected during the transaction may be referred to as transaction data. This scan data includes information about each item sold in a store on a given day, the number of specific items sold, the final sales price, and the like. The scan data includes loyalty transactions and non-loyalty transactions. The scan data for each vendor participating in the loyalty program is uploaded to the loyalty program database on a periodic basis. For example, the scan data for each vendor may be uploaded every 24 hours.

The scan data may be divided into loyalty data 22 and non-loyalty data 24.

The loyalty data 22 includes transaction data specific to loyalty customers. The loyalty data may be combined as general loyalty data (all transaction data associated with loyalty customers at a vendor in the reporting period), may be divided into loyalty-customer loyalty data where each the loyalty data related to each loyalty customer is separated, or may be otherwise parsed.

The non-loyalty data 24 includes transaction data specific to non-loyalty customers.

In various embodiments, any or all of the scan data 20, the loyalty data 22, and the non-loyalty data 24 may be communicated to a manufacturer and/or a vendor.

Data processed and stored at the program hub includes purchase data about past or executed purchases and purchase data about current purchases. As is described more fully below, the purchase data about current purchases may be evaluated against points or rewards earned from past or executed purchases. In some embodiments, only points or rewards earned from past or executed purchases may be used to redeem a program incentive on a current purchase. In other embodiments, points to be earned on the current purchase may be used towards redemption of a program incentive on that purchase.

The loyalty program may be used by a customer at one or a plurality of vendors. The loyalty program communicates in real- or near real-time with the vendor to push rewards for a customer to use during a transaction. The loyalty program tracks what is bought by each customer at what location of what vendor, how many points are accumulated by each customer at what location of what vendor, and what program incentives for what products from what manufacturer are redeemed at what location of what vendor. The loyalty program then coordinates payment from the manufacturer to the correct location of the correct vendor.

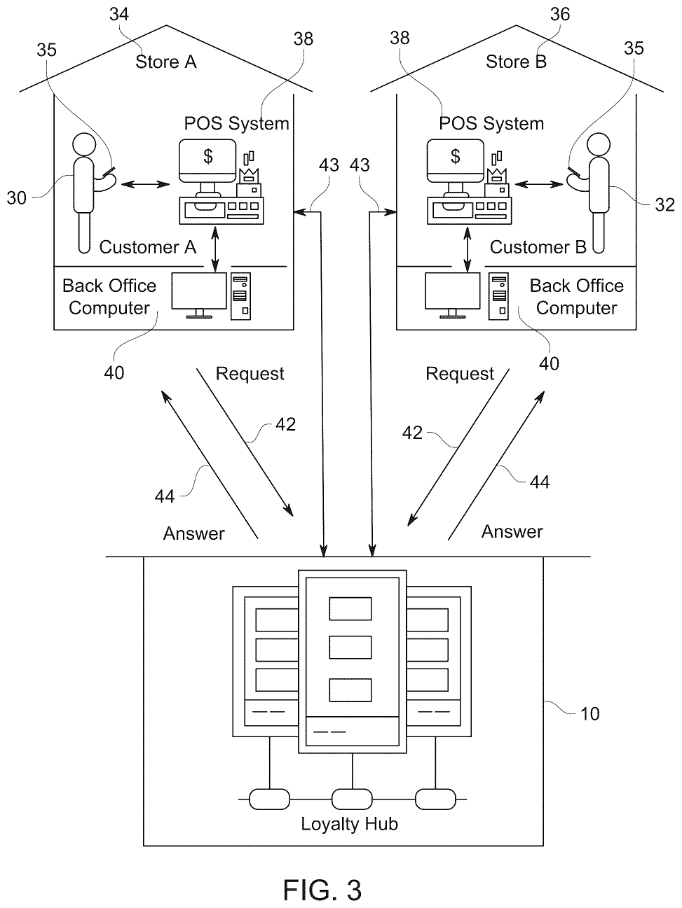

FIG. 3 is a schematic diagram of two customers, Customer A 30 and Customer B 32, each performing transactions at a respective store, Store A 34 and Store B 36, using a loyalty program as disclosed herein. The transactions may be performed on a point of sale system 38. The stores 34, 36 may be of the same vendor 37 or may be of different vendors. The point of sale system 38 communicates to a vendor computer 40, network, or the like, such as a back office computer, which in turn communicates with a hub 10 of the loyalty program, referred to as the loyalty hub or program back end. The customer 30, 32 uses a mobile app 35 of the loyalty program at the POS systems 38 to check in with the loyalty program to execute a transaction. The vendor computer 40 communicates a request 42 related to the current transaction to the loyalty hub 10. The loyalty hub 10 communicates an answer 44 to the respective vendor computer 40. In alternative embodiments, the vendor POS 38 communicates 43 directly with the loyalty hub 10 to send requests to and/or receive answers from the loyalty hub 10. It is to be appreciated that other manners of data flow between the customers 30, 32, stores 34, 36, and loyalty hub 38 may be used.

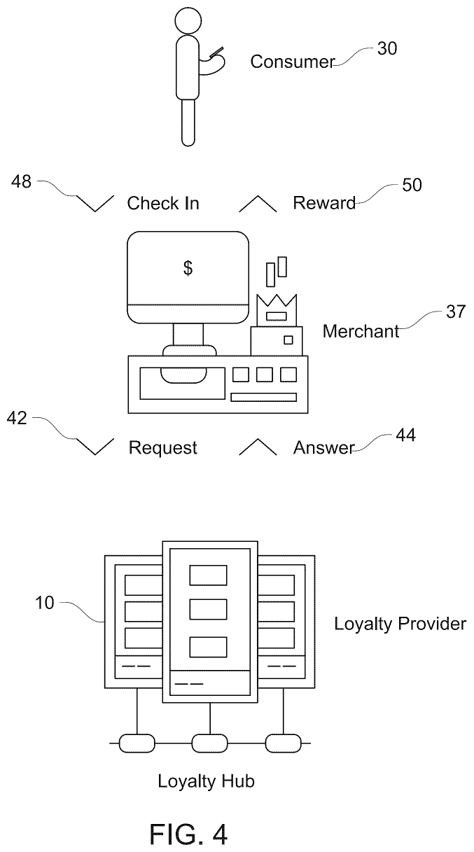

FIG. 4 illustrates data flow between the customer 30, vendor 37, and loyalty hub at the time of a transaction, in accordance with one embodiment. Vendor 37 is used generically in this example and is applicable to any given store at which a customer is executing a transaction. The customer 30 checks in 48, for example by entering or scanning identifying information. The vendor 37 communicates data 42 about the current customer transaction (consumer or customer transaction data) to the loyalty hub 10. That communication may include a request for program incentives. In some embodiments, the customer transaction data communicated by the vendor 37 to the hub 10 may include customer data and transaction data such as what is being purchased. In other embodiments, the customer transaction data communicated 42 by the vendor 37 to the hub 10 may only include that a loyalty customer is making a transaction and data about that customer. The loyalty hub 10 evaluates the customer transaction data communicated by the vendor 37 and provides an answer 44 (program incentives data). That answer may include a program incentive that is applied 50 to the customer transaction at the vendor 37.

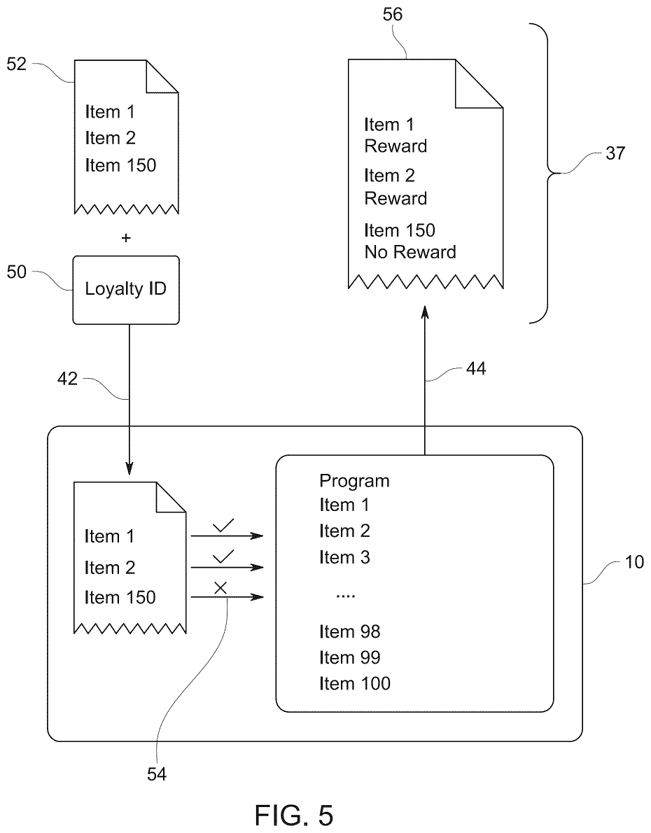

FIG. 5 illustrates further detail about the information sent by the vendor 37 to the hub 10 and the information sent from the hub to the vendor. In some embodiments, the information sent by the vendor 37 to the hub 10 (the consumer transaction data) includes a loyalty identification 50 and a list 52 of items being purchased in the transaction. At the loyalty hub 10, the customer transaction data is evaluated to 54 see if the identified customer is eligible for program incentives on any of the identified items. The hub 10 then communicates 44 program incentives data back to the vendor 37 for application to the transaction 56.

The disclosure provides a loyalty platform, a mobile app, and a rewards program that can span multiple vendors and manufacturers to help vendors achieve maximum profits through customer loyalty participation. The mobile app may be a universal app and/or a vendor specific customized app. For example, the app may be visually customized to display the vendor logo, colors, etc.

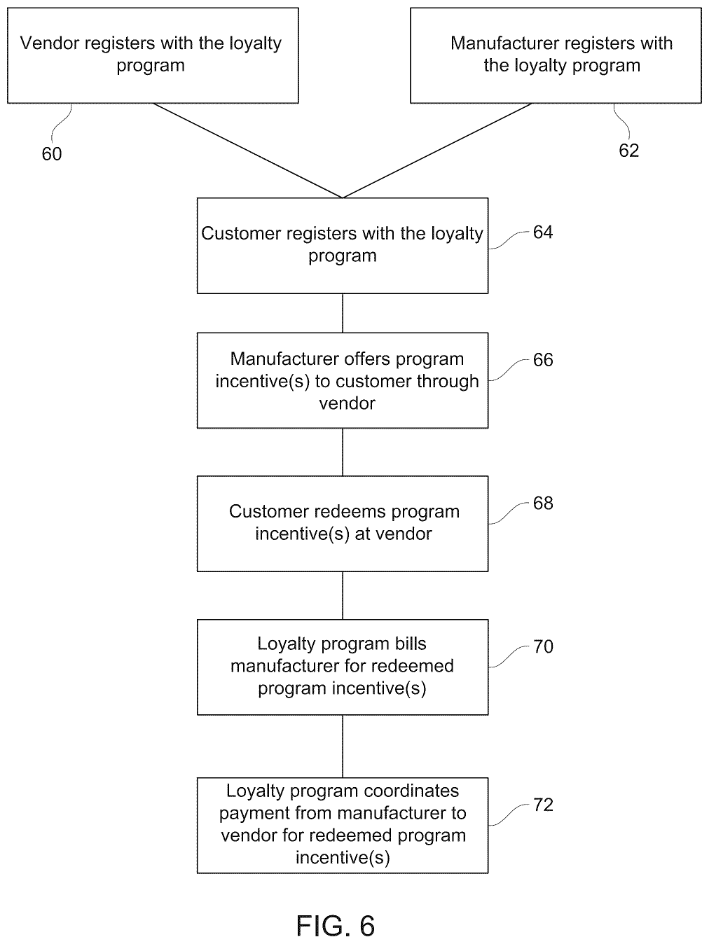

FIG. 6 illustrates broad steps performed within the loyalty program. It is to be appreciated that these steps may be performed in an order other than that shown.

The loyalty program and mobile app provide digital tools to assist a business in maintaining positive customer relationships with its target audiences. More specifically, the app may provide each of the vendor and the manufacturer with important information to develop a customer relationship strategy—the vendor and the manufacturer are able to ascertain the interests of the customer and provide incentives based on those interests. Concurrently, the loyalty program and mobile app may be used to facilitate easy customer use with a plurality of vendors, such as wherein the customer need create only one account that can span a plurality of vendors.

A vendor registers 60 with the loyalty program to offer the loyalty program at one or more of its locations and can customize the mobile app, such as with their colors and/or logo. Using the app, customers can find all of locations of a vendor, view available offers, activate rewards, offers and coupons, track their purchases and points, and cash them in for a variety of program incentives. In one embodiment, program incentives are determined only by the manufacturer and pushed down to all or some vendors. In other embodiments, the program incentives may be coordinated between a vendor and a manufacturer. In some embodiments, a customer can accumulate points, purchase credits, and/or club counts for a specific manufacturer that can then be redeemed at one or more vendor businesses.

A manufacturer registers 62 with the loyalty program to offer program incentives 66 to customers relating to their products through one or more vendors.

A customer registers 64 with the loyalty program using their phone number (or other identifier). The mobile app can offer program incentives, such as deals, discounts, and coupons, etc. that can be applied at the Point of Sale (POS) of a vendor by the customer by logging in-such as by scanning a code or entering a phone number. Program incentives, such as a discount, may be applied to a transaction immediately rather than requiring a customer to wait for a gift card or other to be mailed to them. In some embodiments, program incentives may be applied at any vendor registered with the mobile app, regardless of where rewards were accumulated.

The customer redeems program incentives 68 at a vendor during a transaction. The loyalty program bills the manufacturer 70 for the redeemed program incentives and coordinates payment 72 from the manufacturer to the vendor for the redeemed program incentives. More specifically the amount redeemed on program incentives for any given manufacturer at a specific vendor may be totaled and billed directly to the manufacturer as an amount due. That amount due may be paid directly to the vendor or to the loyalty program as a pass through to the vendor. Such billing may be monthly or at any other time period.

The loyalty program can be used for category gating. For example, geofencing may be used where a customer only gets a particular program incentive if they are at a specific location or in a specific geographic area. This can be useful where a product is only available in that geographic are.

The loyalty program can be used to facilitate vendor compliance with applicable laws and regulations. For example, some program incentives may only be offered to customers of a required legal age. The customer registration process, in some embodiments, may have enhanced verification requirements to ensure accurate date of birth identification.

The loyalty program provides coupon integrity using the scan data analytics. More specifically, the loyalty program tracks what products from what manufacturers are purchased at what location of what vendor. The loyalty program further tracks what program incentives associated with what manufacturers are redeemed at what vendors.

In addition to coupon integrity between the vendor and the manufacture, the loyalty program and associated scan data analytics can be used to assist the vendor in developing a customer relationship strategy. With scan data recording, the vendor has insight into what customers (including, a specific customer) want such that the vendor can make changes to increase business.

The loyalty program may be integrated with any POS systems, including, for example, Verifone-Commander, Gilbarco-Passport and Edge, NCR-Radiant, Pinnacle, Clover, SmartDesq, and NexGo.

In a further embodiment, a method of administering a vendor agnostic loyalty program is provided. The method comprises providing a mobile app, registering a plurality of vendors with the loyalty program, allowing customization of the mobile app for some vendors, registering a customer with the loyalty program, tracking purchases and/or points earned by the customer at all vendors and granting one or more program incentives based on customer qualification such as purchase credits or accumulated points, and allowing redemption of the program incentives at any of the vendors. Each of the program incentives may be associated with a manufacturer. The method may further comprise tracking the awards associated with each manufacturer redeemed at each vendor and billing the manufacturer for payment to the vendor associated with the awards redeemed at that vendor.

### Exemplary Loyalty Program Systemization

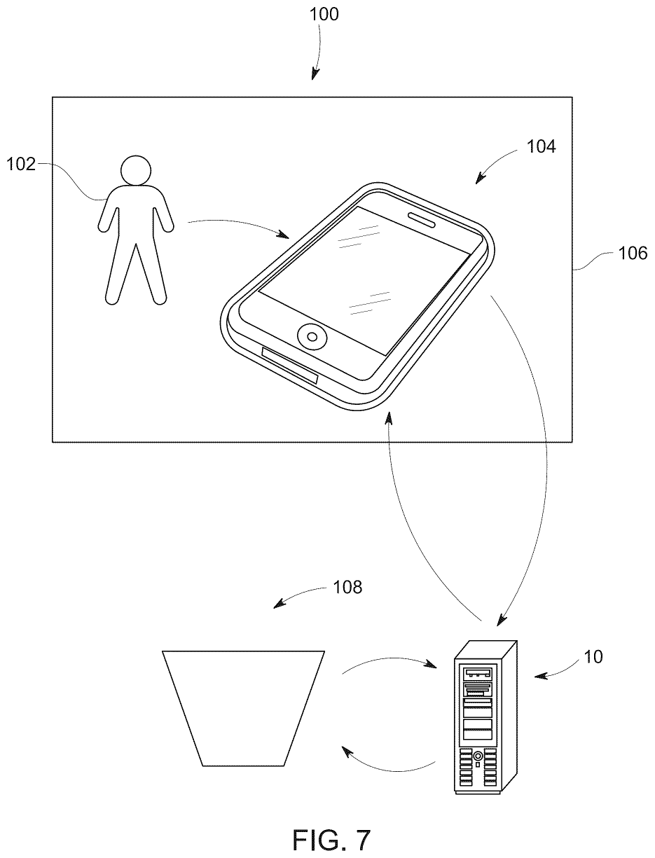

FIG. 7 illustrates parts of a loyalty program system, in accordance with one embodiment. A customer 102 uses a mobile app on a mobile device 104, or provides identifying information to a vendor, for logging into the loyalty program. This may be done at a point of sale of a vendor 106. The vendor 106 has a loyalty program interface on its POS or computer (or similar device), which receives loyalty transaction data from the point of sale. This information is communicated to, and program incentive information is received from, a loyalty program hub 10.

Loyalty program data related to the customer and program incentives is stored at the program hub or server 10. This data may include, for example, Loyalty Customer Info, Vendor Info, Items, Item Groups, Transaction Info, Program Incentive Data, Promo Info, Loyalty Discount Info, Mobile App Engagement Info (including, for example views, opens, clicks), and other data. The vendor computer communicates with the loyalty program server to add information to the server by uploading scan data and to pull information from the server for redemption of loyalty incentives. A manufacturer computer 108, or like device, communicates with the server 500 to gather loyalty data, and optionally non-loyalty data, and to set program incentives.

### Example—Loyalty Program Controller

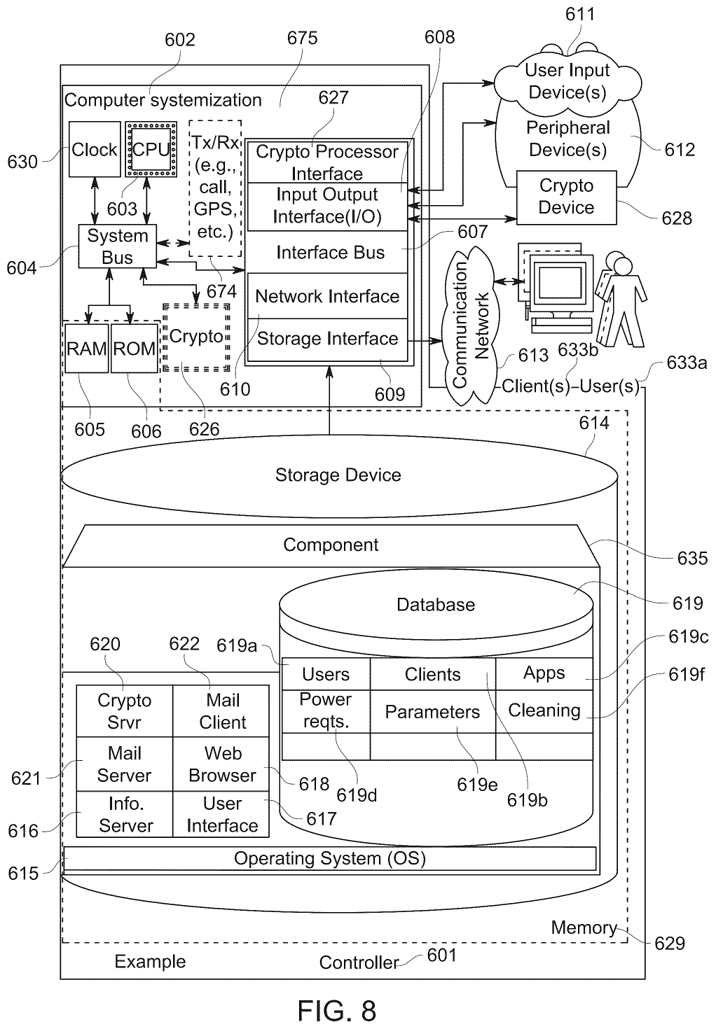

FIG. 8 illustrates aspects of a Loyalty Program controller 601 for controlling a loyalty program system such as that illustrated in FIG. 7. In this embodiment, the Loyalty Program controller 601 may serve to aggregate, process, store, search, serve, identify, instruct, generate, match, and/or facilitate interactions with a computer through various technologies, and/or other related data.

Typically, a user or users, e.g., 633a, which may be people or groups of users and/or other systems, may engage information technology systems (e.g., computers) to facilitate operation of the system and information processing. In turn, computers employ processors to process information; such processors 603 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 629 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the Loyalty Program controller 601 may be connected to and/or communicate with entities such as, but not limited to: one or more users from user input devices 611; manufacturer computers 612; vendor computers (e.g., 100, 100′, 200, 300); an optional cryptographic processor device 628; and/or a communications network 613. For example, the Loyalty Program controller 601 may be connected to and/or communicate with users, e.g., 633a, operating client device(s), e.g., 633b, including, but not limited to, personal computer(s), server(s) and/or various mobile device(s) including, but not limited to, cellular telephone(s), smartphone(s), tablet computer(s), and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The Loyalty Program controller 601 may be based on computer systems that may comprise, but are not limited to, components such as: a computer systemization 602 connected to memory 629.

### Computer Systemization

A computer systemization 602 for the Loyalty Program may comprise a clock 630, central processing unit (“CPU(s)” and/or “processor(s)” (these terms are used interchangeable throughout the disclosure unless noted to the contrary)) 603, a memory 629 (e.g., a read only memory (ROM) 606, a random access memory (RAM) 605, etc.), and/or an interface bus 607, and most frequently, although not necessarily, are all interconnected and/or communicating through a system bus 604 on one or more (mother) board(s) 602 having conductive and/or otherwise transportive circuit pathways through which instructions (e.g., binary encoded signals) may travel to effect communications, operations, storage, etc. Optionally, a cryptographic processor 626 and/or transceivers (e.g., ICs) 674 may be connected to the system bus. In another embodiment, the cryptographic processor and/or transceivers may be connected as either internal and/or external peripheral devices 612 via the interface bus I/O. In turn, the transceivers may be connected to antenna(s) 675, thereby effectuating wireless transmission and reception of various communication and/or sensor protocols.

The system clock may have a crystal oscillator and generate a base signal through the computer systemization's circuit pathways. The clock is typically coupled to the system bus and various clock multipliers that will increase or decrease the base operating frequency for other components interconnected in the computer systemization. The clock and various components in a computer systemization drive signal embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 629 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. In various embodiments, the CPU may be any suitable microprocessor. The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the Loyalty Program controller and beyond through various interfaces. Should processing requirements dictate a greater amount speed and/or capacity, distributed processors, mainframe, multi-core, parallel, and/or super-computer architectures may similarly be employed. Alternatively, should deployment requirements dictate greater portability, smaller Personal Digital Assistants (PDAs) may be employed.

### Interface Adapters

Interface bus (ses) 607 may accept, connect, and/or communicate to a number of interface adapters, conventionally although not necessarily in the form of adapter cards, such as but not limited to: input output interfaces (I/O) 608, storage interfaces 609, network interfaces 610, and/or the like. Optionally, cryptographic processor interfaces 627 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture.

Storage interfaces 609 may accept, communicate, and/or connect to a number of storage devices such as, but not limited to: storage devices 614, removable disc devices, and/or the like. Storage interfaces may employ any suitable connection protocol.

Network interfaces 610 may accept, communicate, and/or connect to a communications network 613. Through a communications network 613, the Loyalty Program controller is accessible through remote clients 633b (e.g., computers with web browsers or mobile devices) by users 633a. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 610 may be used to engage with various communications network types 613. For example, multiple network interfaces may be employed to allow for the communication over broadcast, multicast, and/or unicast networks.

Input Output interfaces (I/O) 608 may accept, communicate, and/or connect to user input devices 611, peripheral devices 612, cryptographic processor devices 628, and/or the like.

User input devices 611 often are a type of peripheral device 612 (see below) and may include: touch screens (e.g., capacitive, resistive, etc.), keyboards, mouses, trackballs, trackpads, microphones, sensors (e.g., accelerometers, ambient light, GPS, gyroscopes, proximity, etc.), styluses, and/or the like.

Cryptographic units such as, but not limited to, microcontrollers, processors 626, interfaces 627, and/or devices 628 may be attached, and/or communicate with the Loyalty Program controller.

### Memory

Generally, any mechanization and/or embodiment allowing a processor to affect the storage and/or retrieval of information is regarded as memory 629. However, memory is a fungible technology and resource, thus, any number of memory embodiments may be employed in lieu of or in concert with one another. It is to be understood that the Loyalty Program controller and/or a computer systemization may employ various forms of memory 629. For example, a computer systemization may be configured wherein the functionality of on-chip CPU memory (e.g., registers), RAM, ROM, cloud storage, or other. In a typical configuration, memory 629 will include ROM 606, RAM 605, and a storage device 614. The storage device 614 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 629 may contain a collection of program and/or database components and/or data such as, but not limited to: operating system component(s) 615 (operating system); information server component(s) 616 (information server); user interface component(s) 617 (user interface); Web browser component(s) 618 (Web browser); database(s) 619; mail server component(s) 621; mail client component(s) 622; cryptographic server component(s) 620 (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device 614, they may also be loaded and/or stored in memory such as: peripheral devices, RAM, remote storage facilities through a communications network, ROM, various forms of memory, and/or the like.

### Operating System

The operating system component 615 is an executable program component facilitating the operation of the Loyalty Program controller. Typically, the operating system facilitates access of I/O, network interfaces, peripheral devices, storage devices, and/or the like. The operating system may be any suitable operating system known in the art. The operating system may communicate to and/or with other components in the component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the Loyalty Program controller to communicate with other entities through a communications network 613.

### Information Server

An information server component 616 is a stored program component that is executed by a CPU. The information server may be a suitable Internet information server. The information server may allow for the execution of program components. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like.

The information server may provide results in the form of Web pages to Web browsers, and allows for the manipulated generation of the Web pages through interaction with other program components. The information server may communicate to and/or with other components in a component collection, including itself, and/or facilities of the like. Most frequently, the information. server communicates with the Loyalty Program database 619, operating systems, other program components, user interfaces, Web browsers, and/or the like.

Access to the Loyalty Program database(s) may be achieved through a number of database bridge mechanisms such as through scripting languages as enumerated below (e.g., CGI) and through inter-application communication channels as enumerated below (e.g., CORBA, WebObjects, etc.). Any data requests through from an entity are parsed through the bridge mechanism into appropriate grammars as required by the Loyalty Program. In one embodiment, the parser may generate queries in standard SQL by instantiating a search string with the proper join/select commands based on the tagged text entries, wherein the resulting command is provided over the bridge mechanism to the Loyalty Program as a query. Upon generating query results from the query, the results are passed over the bridge mechanism, and may be parsed for formatting and generation of results by the bridge mechanism. Such new results are then provided to the information server, which may supply them to the requesting entity.

Also, an information server may contain, communicate, generate, obtain, and/or provide program component, system, user, and/or data communications, requests, and/or responses.

### User Interface

Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) may be used to display information graphically to users.

A user interface component 617 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 618 is a stored program component that is executed by a CPU. The Web browser may be a conventional hypertext viewing application. The Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the Loyalty Program enabled nodes.

### Mail Server

A mail server component 621 is a stored program component that is executed by a CPU 603. The mail server may be an Internet mail server such as is known in the art. The mail server can route, forward, and process incoming and outgoing mail messages that have been sent, relayed and/or otherwise traversing through and/or to the Loyalty Program.

Access to the Loyalty Program mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 622 is a stored program component that is executed by a CPU 603. The mail client may be any suitable mail viewing application such as is known in the art. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 620 is a stored program component that is executed by a CPU 603, cryptographic processor 626, cryptographic processor interface 627, cryptographic processor device 628, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data.

The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the Loyalty Program component to engage in secure transactions if so desired. The cryptographic component facilitates the secure accessing of resources on the Loyalty Program and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The Loyalty Program Database

The Loyalty Program database component 619 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the Loyalty Program database(s) may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the Loyalty Program database is implemented as a data-structure, the use of the Loyalty Program database 619 may be integrated into another component such as the Loyalty Program component 635. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

The Loyalty Program database may communicate to and/or with other components in a component collection, including itself, and/or facilities of the like. Most frequently, the Loyalty Program database communicates with the Loyalty Program component, other program components, and/or the like. The database may contain, retain, and provide information regarding other nodes and data.

### The Loyalty Program Components

The Loyalty Program component 635 is a stored program component that is executed by a CPU. In one embodiment, the Loyalty Program component incorporates any and/or all combinations of the aspects of the Loyalty Program systems discussed in the previous figures. As such, the Loyalty Program component affects accessing, obtaining and the provision of information, services, transactions, and/or the like across various communications networks.

The Loyalty Program component enabling access of information between nodes may be developed by employing standard development tools and languages. The Loyalty Program component may communicate to and/or with other components in a component collection, including itself, and/or facilities of the like. Most frequently, the Loyalty Program component communicates with the Loyalty Program database, operating systems, other program components, and/or the like. The Loyalty Program may contain, communicate, generate, obtain, and/or provide program component, system, user, and/or data communications, requests, and/or responses.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a minicomputer, mainframe computer, personal computer (e.g., desktop or laptop), tablet computer, embedded computer, mobile device (e.g., personal digital assistant (PDA) or smart phone) or other hand-held computing device, server (e.g., blade server or rack server), a network storage device, or any other suitable device or combination of devices and may vary in size, shape, performance, functionality, and price. A system may include volatile memory (e.g., random access memory (RAM)), one or more processing resources such as a central processing unit (CPU) or hardware or software control logic, ROM, and/or other types of nonvolatile memory (e.g., EPROM, EEPROM, etc.). A basic input/output system (BIOS) can be stored in the non-volatile memory (e.g., ROM), and may include basic routines facilitating communication of data and signals between components within the system. The volatile memory may additionally include a high-speed RAM, such as static RAM for caching data.

Hardware and software components of the present disclosure, as discussed herein, may be integral portions of a single computer, server, controller, or message sign, or may be connected parts of a computer network. The hardware and software components may be located within a single location or, in other embodiments, portions of the hardware and software components may be divided among a plurality of locations and connected directly or through a global computer information network, such as the Internet. Accordingly, aspects of the various embodiments of the present disclosure can be practiced in distributed computing environments where certain tasks are performed by remote processing devices that are linked through a communications network. In such a distributed computing environment, program modules may be located in local and/or remote storage and/or memory systems.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A loyalty program system comprising:
a mobile app usable by a customer at a plurality of vendors;
a program hub that tracks executed purchases made by the customer at each of the vendors and loads program incentives earned by the customer based on the executed purchases for redemption for future purchases at one of the plurality vendors to the mobile app;
a vendor interface, wherein the vendor interface communicates transaction data and customer purchase data to the program hub;
a manufacturer interface, wherein the manufacturer interface communicates one or more program incentives available for the customer to the program hub;
wherein the customer provides customer identifying information to one of the plurality of vendors when making a current purchase, the vendor interface communicates the current customer purchase data and the customer identifying information to the program hub, the program hub communicates an available program incentive for the current purchase to the vendor interface, and the vendor interface applies the available program inventive to the current purchase.

2. The loyalty program system of claim 1, wherein the transaction data includes scan data and loyalty data.

3. The loyalty program system of claim 1, wherein the loyalty data includes what products were purchased by the customer using the loyalty program at what time at which one of the plurality of vendors.

4. The loyalty program system of claim 2, wherein the loyalty data is communicated by the program hub to the manufacturer.

5. The loyalty program system of claim 2, wherein the loyalty data is communicated by the program hub to the plurality of vendors.

6. The loyalty program system of claim 1, wherein the program hub tracks a value for redeemed program incentives at one of the plurality of vendors for the manufacturer and coordinates payment of the value from the manufacturer to the one of the plurality of vendors.

7. The loyalty program system of claim 1, wherein the mobile app may be customized for one or more of the plurality of vendors.

8. The loyalty program system of claim 1, wherein the program hub stores customer information and vendor information.

9. The loyalty program system of claim 1, wherein the program incentive comprises a deal, discount, or coupon.

10. A method of administering a vendor agnostic loyalty program, the method comprising:
registering a plurality of vendors with the loyalty program;
providing a mobile app for use by a customer at each of the plurality of vendors;
registering a customer with the loyalty program;
registering a manufacturer with the loyalty program;
receiving from the manufacturer a program incentive for redemption by the customer at at least one of the plurality of vendors;
tracking purchases made by the customer at each of the vendors;
establishing when the customer's purchases have qualified the customer for the program incentive; and
communicating the program incentive to one of the plurality of vendors for use on a current purchase by the customer.

11. The method of claim 10, further comprising receiving transaction data from the plurality of vendors.

12. The method of claim 11, wherein the transaction data includes scan data and loyalty data.

13. The method of claim 12, wherein the loyalty data includes what products were purchased by the customer using the loyalty program at what time at which one of the plurality of vendors.

14. The method of claim 13, further comprising communicating the loyalty data to the manufacturer.

15. The method of claim 14, further comprising communicating the loyalty data to the one of the plurality of vendors.

16. The method of claim 10, further comprising applying the program incentive to the current purchase.

17. The method of claim 16, further comprising coordinating payment from the manufacturer to the one of the plurality of vendors for a value of the program incentive applied to the current purchase.

18. The method of claim 10, further comprising evaluating customer information for compliance with legal requirements for the current purchase.

19. The method of claim 10, wherein the program incentive comprises a deal, discount, or coupon.

20. A vendor agnostic loyalty program comprising:
a customer module, wherein the customer module includes a customer profile for a customer, the customer profile including customer information relating to the customer including identifying information relating to the customer;
a vendor module, wherein the vendor module includes a vendor profile for a plurality of vendors, the vendor profile including vendor information relating to each vendor;
a manufacturer module, wherein the manufacture module includes a manufacturer profile for a plurality of manufacturers, the manufacturer profile including manufacturer information relating to each manufacturer;
a program hub, wherein the program hub stores information from the customer module, vendor module, and the manufacturer module;
a mobile app usable by the customer at the plurality of vendors, wherein the mobile app tracks executed purchases made by the customer at each of the vendors and loads program incentives earned by the customer based on the executed purchases for redemption for future purchases at one of the plurality vendors;
a vendor interface, wherein the vendor interface communicates transaction data and customer purchase data to the program hub;
a manufacturer interface, wherein the manufacturer interface communicates one or more program incentives available for the customer to the program hub;
wherein the customer can use the loyalty program at each of the plurality of vendors.
